(19) United States
(12) Patent Application Publication
(10) Pub. No.: US 2013/0110835 A1
(43) Pub. Date: May 2, 2013

(54) METHOD FOR CALCULATING PROXIMITIES BETWEEN NODES IN MULTIPLE SOCIAL GRAPHS

(71) Applicant: Zhijiang He, Sunnyvale, CA (US)

(72) Inventor: Zhijiang He, Sunnyvale, CA (US)

(73) Assignee: Zhijiang He, Sunnyvale, CA (US)

(21) Appl. No.: 13/317,794

(22) Filed: Oct. 28, 2011

(51) Int. Cl. G06F 17/30

(52) U.S. Cl. 707/737; 707/748; 707/E17.089; 707/E17.014

(57) ABSTRACT

The present invention discloses a method for calculating proximities between nodes in multiple social graphs. Some nodes in one social graph may be mapped to nodes in other social graphs. To describe the closeness of relation between nodes, weighting factors are assigned to the relations in a social graph. Social graphs representing same type of relations may be merged into one graph to model the relations between nodes more accurately and completely. The weighting factors for relations in the merged social graph may be calculated from the weighting factors for relations in the original graphs. Relations in social graphs may be either attenuatable or non-attenuatable. The proximities between nodes may be calculated from the weighting factors for relations on the paths connecting them. The calculated proximities may be used to improve the performance of search in multiple social graphs.

### CROSS-REFERENCE TO RELATED APPLICATIONS

Ser. No. 13/317,270, “A method for calculating distances between users in a social graph”, Oct. 13, 2011, pending, Zhijiang He

### FEDERALLY SPONSORED RESEARCH

Not Applicable

### SEQUENCE LISTING OR PROGRAM

Not Applicable

### US PATENT REFERENCES

Not Applicable

### OTHER REFERENCES

“Six degrees of separation”, http://en.wikipedia.org/wiki/Six_degrees_of_separation
“Cluster analysis”, http://en.wikipedia.org/wiki/Cluster_analysis
“Iterative deepening depth-first search”, http://en.wikipedia.org/wiki/Iterative_deepening_depth-first_search

### FIELD OF THE INVENTION

The present invention relates generally to techniques of search in multiple social graphs. Some nodes in one social graph may be mapped to nodes in other social graphs. More specifically, it calculates the proximities between nodes in multiple social graphs.

### BACKGROUND OF THE INVENTION

Due to the number of users and the amount of time a user may spend everyday, online social networking has been becoming increasingly important in people's life. Large databases of social connections, i.e. social graphs, have been established. A node in a social graph represents a user or an entity. A connection between two nodes represents a relation between the two corresponding users/entities.

There are a variety of social graphs. For instance, the social graphs of Facebook and Google+ represent friendship between users. The social graph of LinkedIn represents professional links between users. The social graph of Twitter represents following relations between users.

Social graphs representing same type of relations may be merged into one social graph. For instance, the social graphs of Facebook and Google+ may be merged into one friendship graph, which describes the friendship between users more accurately and completely.

Social graphs may also be used to describe business relations. A medical social graph may describe relations between doctors and patients. A commercial social graph may describe relations between buyers and sellers.

The relations in popular social graphs are dense. A node in a popular social graph may have hundreds of connections. According to the 6 degrees of separation, there may be on average 5 users between any two users in the social graph of a popular social networking service.

Nonetheless, some social graphs are sparse. For instance, a seller may have a limited number of buyers. Conversely, a buyer may also only have a limited number of choices of sellers. It is a challenge for both buyers and sellers to find more choices. Sellers may use various approaches to connect to potential buyers. Meanwhile, buyers also want to have more choices for better products and services.

In real life, a buyer may ask his/her friends for referral of sellers. His/her friends may ask their friends for referral. Furthermore, to sell more products/services, a seller may also ask customers to recommend products/services to customers' friends. In this real life example, relations in a friendship social graph may be used to find possible new business relations in a business social graph.

This phenomenon serves as the foundation for search in multiple social graphs. The goal of a search in multiple social graphs is to find a list of matched nodes using relations in the social graphs.

Common methods for search in social graphs include breath-first or similar approaches. Unfortunately, a node in social graphs may have hundreds of connections. The large branching factor may dramatically increase the computation cost. This problem is particularly true for search in multiple social graphs.

To handle the large branching factor problem, the nodes in social graphs may be sorted in terms of closeness of relation with respect to the source nodes. Nodes with closer relation to the source nodes are searched first. Moreover, the scope of the search may also be constrained.

Proximities may be used to describe the closeness of relation between nodes in social graphs. To calculate proximities, weighting factors are assigned to relations in the social graphs. The proximities between two nodes in social graphs may be calculated from the weighting factors for relations on the paths connecting the two nodes in the social graphs.

Accordingly, it is an object of this invention to calculate the proximities between nodes in multiple social graphs to facilitate search in multiple social graphs.

### BRIEF SUMMARY OF THE INVENTION

The present invention provides a method for calculating proximities between nodes in multiple social graphs. The relations in a social graph may have distinct importance. Therefore, weighting factors are assigned to the relations in a social graph. The proximities between nodes describe the closeness of relation in the social graphs. Larger proximity from one node to the other means closer relation between the two nodes. The proximities between nodes may be calculated from the weighting factors for relations on the paths connecting the two nodes. If two nodes have no path connecting them, then the proximity between them is zero. According to the calculated proximities from one or more source nodes, search in social graphs may be performed in the order of non-increasing proximities from the source nodes.

A person in real life may know hundreds of people. Nonetheless, he/she may have close relations with only very few of them. His/her relations with the remaining friends may be relatively looser. In other words, a person's friends are tiered. This is also true for the relations of a node in social networking. This phenomenon serves as the theoretical foundation for calculating proximities between nodes in social graphs. If two nodes have close direct/indirect relation, the proximities between the two nodes are also large. The concept of proximity makes it possible to measure the closeness of relation across neighbors in social graphs.

A search in multiple social graphs may be performed in the order of non-increasing proximities from the source nodes. The search scope may be constrained with a predetermined cutoff proximity. Nodes with smaller proximities from the source nodes than the predetermined cutoff proximity will not be searched.

Social graphs representing same type of relations may be merged into one graph. The importance ranks for nodes and the weighting factors for relations in the merged graph may be derived from the importance ranks for nodes and the weighting factors for relations in the original graphs. In this way, the merged graph may model the relations between nodes more accurately and completely.

When propagated along a path in social graphs, some relations may be attenuated. Relations having this propagation attribute are defined as attenuatable relations. For instance, relations in a friendship social graph are attenuatable. A propagated friendship between two strangers sharing a common friend may not be as close as their friendship with their common friend. In other words, the proximities between two strangers sharing a common friend may be smaller than their proximities from their common friend.

Nonetheless, some relations may not be attenuated when propagated along a path. These relations are defined to be non-attenuatable relations. For instance, the relation between a customer and a restaurant is non-attenuatable. A customer may have a high opinion about a restaurant. Upon the customer's recommendation, his/her friends who have never visited the restaurant may also have a high opinion about the restaurant. The relation between the customer and the restaurant is not attenuated when propagated to his/her friends. That is, the proximities between the customer's friends and the restaurant may be equal to the proximities between the customer and the restaurant.

Proximities between two nodes in social graphs may be calculated from the weighting factors for relations on the paths connecting the two nodes. The methods for calculating proximities of non-attenuatable relation between two nodes are distinct from the methods for calculating proximities of attenuatable relation between two nodes.

### BRIEF DESCRIPTION OF THE DRAWINGS

FIG. 1 shows a diagram for a 3-user social graph with weighting factors according to the invention.

FIG. 2 shows a diagram for a social graph with weighting factors, path proximities and proximities according to the invention.

FIG. 3 shows a social graph where the connecting path via a third user has the largest path proximity between two users according to the invention.

FIG. 4 shows a diagram for two social graphs representing same type of relations according to the invention.

FIG. 5 shows a diagram for a merged social graph from the two social graphs in FIG. 4 according to the invention.

FIG. 6 shows that proximities in one social graph are used to calculate proximities in another social graph according to the invention.

FIG. 7 shows a flow chart of one embodiment of the invention.

### DETAILED DESCRIPTION OF THE INVENTION

In the following description, numerous specific details are set forth in order to provide a thorough understanding of the invention. It will be apparent to one skilled in the art, however, that the present invention may be practiced without these specific details. Accordingly, the following embodiments of the invention are set forth without any loss of generality to, and without imposing limitations upon, the claimed invention.

Given n undirected social graphs Gₖ(Vₖ, Eₖ), where kε[0, n−1]. Vₖ represents the set of nodes in Gₖ and Eₖ represents the set of edges connecting the nodes in Vₖ. Essentially, Vₖ is the set of users/entities in a social networking service and Eₖ describes the relations between the users/entities. Nodes in one graph Gᵢ may be mapped to nodes in another graph Gⱼ, where i, jε[0, n−1]. That is, Gᵢ and Gⱼ share some common nodes.

The multiple social graphs may be obtained from various social networking services. Nonetheless one social networking service may also have multiple social graphs. Each graph represents a type of relation between nodes.

Nodes in social graphs represent entities registered with social networking services, including but not limited to users, celebrities, public figures, artists, bands, groups, companies, businesses, organizations, institutions, places, events, brands, products and services.

Each node vᵢ in a social graph G is assigned an importance rank rᵢ. In one embodiment of the invention, an importance rank may be determined from a node's profile, join time, last access time, activities, locations, interests, membership of groups, events and preferences.

Part of the value of a social graph is the closeness of relation it conveys. Although a node may have hundreds of connections, the connections may carry disparate levels of closeness. In one embodiment of the present invention, family relation carries a high level of trust. In another embodiment of the invention, if there are more communications between two nodes, the relation between them may be closer as well.

To model the closeness of relation between nodes, the present invention assigns weighting factors to the relations in a social graph. For a relation eᵢⱼ in graph G(V, E), wᵢⱼ is used to describe the closeness of relation from vᵢ to vⱼ.

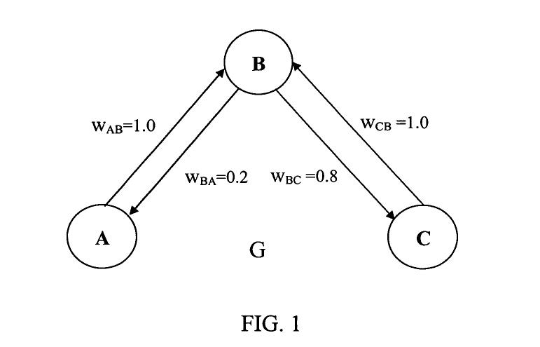

One embodiment of the present invention is shown in FIG. 1. It is a friendship graph G with user A, B and C. The weighting factors for relations between users are given in FIG. 1. The weighting factor for the relation from A to B w_{AB} is 1.0 while the weighting factor for the relation from B to C w_{BC} is 0.8. There is no direct relation between A and C. However, in real world, A may connect to C via B. In other words, relations may be propagated along a path connecting the two nodes. Moreover, the propagated relations may be attenuated during propagation. In the present invention, the propagation attribute of this relation is defined to be attenuatable. Not all relations are attenuatable. Non-attenuatable relations will be described later in this section.

From the perspective of probability, the weighting factors for attenuatable relations may be interpreted as a predetermined probability of selecting the next node from the current node's neighbors to traverse when searching a social graph. As the next node to visit is always one of vᵢ's neighbors in a social graph, the sum of all weighting factors for relations sourced from vᵢ is 1. That is,

$${\sum }_{j} {w}_{ij} = 1$$

Apparently, wᵢⱼ and wⱼᵢ are not necessarily equal. For this reason, the original undirected G(V, E) is converted to a directed graph G′(V, W), where an edge eᵢⱼ/eⱼᵢ in G is split into two directed edges wᵢⱼ and wⱼᵢ in G′.

wᵢⱼ may be obtained from the closeness of relation from vᵢ to vⱼ in a social graph. In one embodiment of the present invention, it may be derived from the communications between node vᵢ and vⱼ. In another embodiment of the present invention, it may be dependent on the nodes' importance rank rᵢ and rⱼ, which may be calculated from the nodes' profiles, join times, last access times, activities, locations, interests, membership of groups, events and preferences.

In one embodiment of the present invention, if there is no relation closeness information available, the weighting factor for the attenuatable relation from vᵢ to vⱼ in a social graph G may be calculated as

wᵢⱼ=1/n

where n is the number of relations node vᵢ has in G.

Proximities between two nodes describe closeness of the two nodes in a social graph. If the proximity from one node to another is large, the relation between them is close too. Proximities may be calculated from the weighting factors for relations in the graphs. More specifically, the proximities between two nodes are determined from the weighting factors for relations on the paths connecting the two nodes.

There may be a number of paths from a first node to a second node. If the propagated relations between two nodes are attenuatable, path proximity may be defined to describe the propagated relations from the first node to the second node along a path. In one embodiment of the present invention, the proximity pᵢⱼ from node vᵢ to vⱼ is defined as

$${p}_{ij} = {max}_{l} {pp}_{ijl}$$

which is the maximum path proximity from vᵢ to vⱼ. ppᵢⱼₗ is the proximity for path l. Path l is one of the paths connecting vᵢ to vⱼ.

Similar to the asymmetry of weighting factors, proximities are asymmetric as well. Specifically, proximity pᵢⱼ may not be equal to pⱼᵢ.

The proximity of a path may be calculated from the weighting factors for relations on the path. Moreover, the probability of visiting node vⱼ from vᵢ following a path should be the multiplication of the probabilities of connections on the path. Therefore, in one embodiment of the present invention, the path proximity ppₒ may be calculated as

ppᵢⱼₗ=Πwₛₜ

where wₛₜ is the weighting factor for the relation from vₛ to vₜ on path l connecting vᵢ to vⱼ.

The propagation of attenuatable relation across neighboring nodes should be an attenuating process. A propagation coefficient α is defined and should be in the interval of [0, 1]. Accordingly, in one embodiment of the present invention, the path proximity ppᵢⱼₗ may be defined as

ppᵢⱼₗ=Πw′ₛₜ

where w′ₛₜ is equal to α*wₛₜ except for the last connection on the path. The w′ₛₜ for the last connection on the path is equal to wₛₜ.

Given the 6 degrees of separation, a recommendation is to select α⁷=ε where ε is the truncation error of the method. For instance, if ε is 0.001, α would be 0.373.

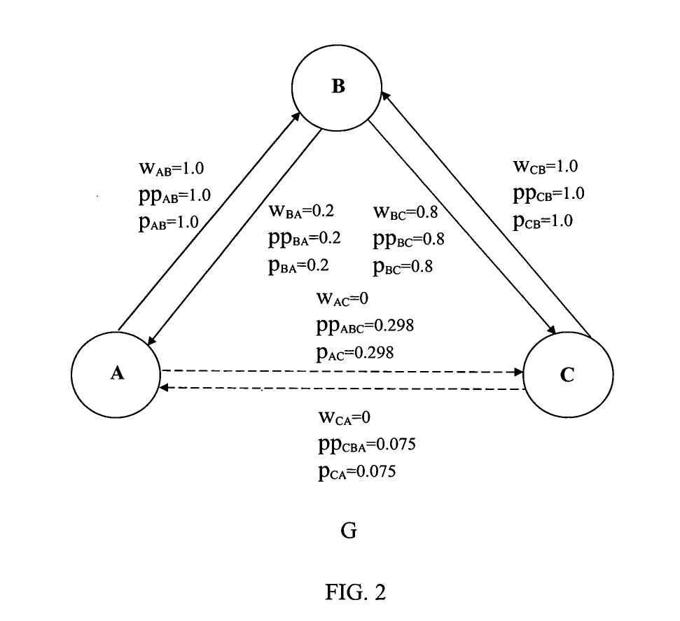

One embodiment of the present invention is FIG. 2. It shows the same social graph as in FIG. 1. The path proximities pp_{AB}, pp_{BA}, pp_{BC}, pp_{CB}, pp_{BA}, pp_{ABC} are given in FIG. 2. pp_{ABC} is calculated as 1.0*0.373*0.8=0.298. Similarly, pp_{CBA} is calculated as 1.0*0.373*0.2=0.075. In this example, the path proximities between users are equal to the proximities between users.

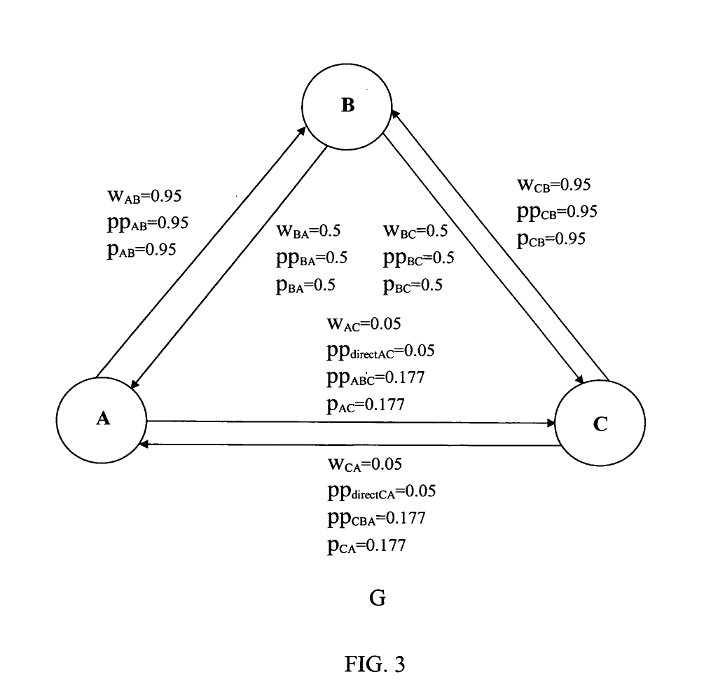

The metric of social proximity may be count-intuitive. The largest path proximity between two nodes may not be the path proximity of the direct connection between the two nodes. FIG. 3 shows an example. The path proximity of the direct connection from A to C is 0.05. However, the path proximity from A to C via B is 0.95*0.373*0.5=0.177. This is possible in real life. Two people A and C may not have close relation between them. Nonetheless, A and C may share a very close common friend B. The communication between A and C via B may be more effective than the direct communication between A and C.

In one embodiment of the present invention, iterative deepening depth-first traversal may be applied on a source node. The depth limit for the iterative deepening depth-first traversal is a predetermined depth, for instance, 6. If the multiplication of weighting factors for relations on a path is smaller than a predefined truncation error ε, then the propagation along this path is stopped. Furthermore, the neighbors of a source node are visited in the order of non-increasing weighting factors.

When the proximities between nodes are available, search in social graphs may be conducted from source nodes in the non-increasing order of proximities from the source nodes. Nodes with larger proximities from the source nodes are searched first. The search may be stopped if the proximities from the source nodes are smaller than a predetermined cutoff proximity.

Moreover, distances between nodes in social graphs may be derived from the calculated proximities. In one embodiment of the present invention, the distance from a first node to a second node may be calculated as the reciprocal of the proximity from the first node to the second node.

Based on the calculated distances, clusters may be created from social graphs to enhance the performance of social search. Various clustering techniques may be used. In one embodiment of the present invention, density based clustering may be used. In another embodiment of the present invention, the hierarchical approaches may be used. The hierarchical clustering may be created in various ways. In one embodiment of the present invention, a hierarchy may be created in an agglomerative way. In another embodiment of the present invention, a hierarchy may be created in a divisive way.

Some social graphs may represent same type of relations. For instance, some users may have accounts in both Facebook and Google+. Accordingly, the Facebook graph G_{Facebook} and the Google+ graph G_{Google+} share some common users. Moreover, as both G_{Facebook} and G_{Google+} represent friendship between users, it is possible to merge these two graphs into one graph G′. The users' ranks and the relations' weighting factors in G′ may be calculated from the users' ranks and the relations' weighting factors in G_{Facebook} and G_{Google+}.

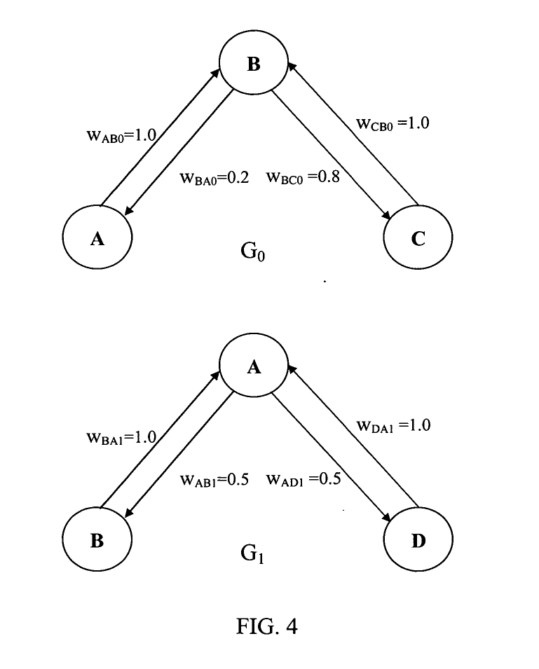

FIG. 4 shows two social graphs G₀ and G₁ with weighting factors. G₀ has user A, B and C while G₁ has user A, B and D. A and B are in both G₀ and G₁. Moreover, G₀ and G₁ represent same type of relations. Therefore, G₀ and G₁ may be merged into one graph to model the relations between users more accurately and completely.

Social graphs representing same type of relations may be merged in various ways. Supposedly there are m graphs Gₖ, where kε[0, m−1]. The m graphs represent same type of relations. wᵢⱼₖ is the weighting factor for the relation from vᵢ to vⱼ in Gₖ. In one embodiment of the present invention, the weighting factor w′ᵢⱼ for the relation from vᵢ to vⱼ in the merged graph G′ may be calculated as a weighted sum of the weighting factors wᵢⱼₖ in the original graphs, where kε[0, m−1]. The weighting for relations sourced from vᵢ in Gₖ is wwᵢₖ. wwᵢₖ represents the importance of Gₖ's relations from vᵢ in the merged graph G′. In one embodiment of the present invention, wwᵢₖ may be determined in terms of the communications sourced from node vᵢ.

The un-normalized weighting factor w″ᵢⱼ for the relation from vᵢ to vⱼ in G′ may be calculated as

$${w}_{ij}^{″} = {\sum }_{k} {ww}_{ik} * {w}_{ijk}$$

The normalized weighting factor w′ᵢⱼ for the relation in G′ may be computed as

$${w}_{ij}^{′} = \frac{{w}_{ij}^{″}}{{\sum }_{l} {w}_{il}^{″}}$$

where vₗ is one of the nodes having relations with vᵢ in G′ including vⱼ. w″ᵢₗ is the un-normalized weighting factor for the relation from vᵢ to vₗ in G′. The denominator is a sum of all the un-normalized weighting factors for relations sourced from vᵢ in G′.

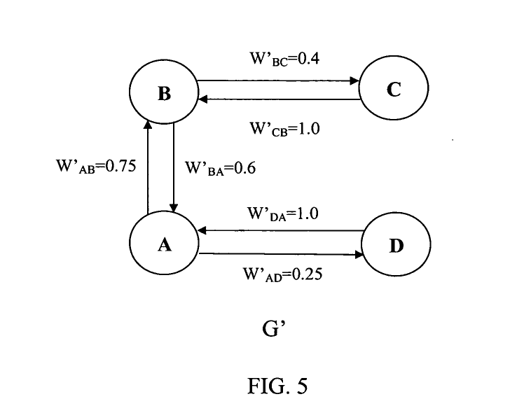

FIG. 5 shows a merged graph G′ of the two social graphs shown in FIG. 4. In this embodiment of the present invention, weighting factors in G₀ and G₁ are assigned according to the communications between users. Therefore, the weighting factors in G′ may be calculated according to the same criterion. More specifically, it is assumed that each node in G₀ has the same amount of communication as in G₁. In other words, ww_{A0}=ww_{A1}=0.5, ww_{B0}=ww_{B1}=0.5.

User A has relations with B and D in G′. The un-normalized weighting factor for the relation from A to B w″_{AB}=ww_{A0}*w_{AB0}+ww_{A1}*w_{AB1}=0.5*1.0+0.5*0.5=0.75. The un-normalized weighting factor for the relation from A to D w″_{AD}=ww_{A1}*w_{AD1}=0.5*0.5=0.25. After normalization, w′_{AB}=w′_{AB}/(w″_{AB}+w″_{AD})=0.75/(0.75+0.25)=0.75. w′_{AD}=w″_{AD}/(w″_{AB}+w″_{AD})=0.25/(0.75+0.25)=0.25. Similarly, w′_{BA} and w′_{BC} may be calculated as 0.6 and 0.4 respectively.

As mentioned earlier, not all relations are attenuatable. If relations for a node in the graphs are not attenuatable, the weighting factors for the node's relations may not be interpreted from the probability perspective.

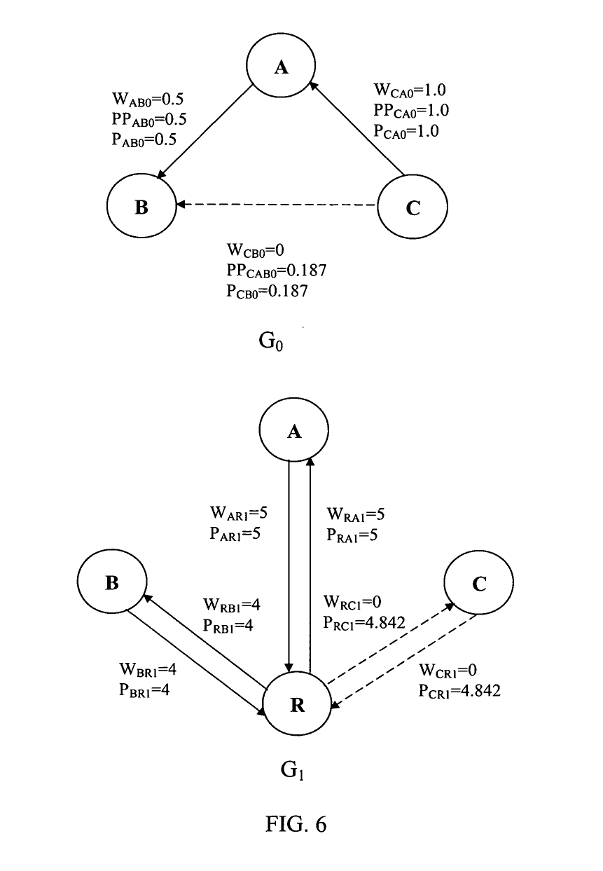

One example is given in FIG. 6. Note that not all relations are shown in FIG. 6. There are two graphs G₀ and G₁ in this example. G₀ is a friendship graph. G₁ is a restaurant and customer relation graph. Node R represents a restaurant. A and B are customers for this restaurant. The weighting factor W_{AR1} describes the relation from A to R and is assigned the review of customer A for restaurant R, which is 5 in the scale of [0, 5]. Similarly, the weighting factor w_{BR1} describes the relation from B to R and is assigned the review of customer B for restaurant R, which is 4. Customer A and B in G₁ are mapped to user A and B in G₀.

There is no relation from user C to restaurant R, which means user C may have never been to restaurant R. C may ask his/her friends A and B about restaurant R. In this way, C may get an opinion about restaurant R from A and B. Apparently, the restaurant and customer relation is not attenuatable. In the present invention, the propagation attribute of the restaurant and customer relation is defined to be non-attenuatable.

FIG. 6 is an interesting example. It shows that it is possible to predict relations between nodes in G₁ based on the relations in G₀ and the relations in G₁. The attenuatable relations in G₀ may be used to find nodes relevant to the source node and having non-attenuatable relations in G₁. This example demonstrates the advantage of search in multiple social graphs.

As stated previously, calculating proximities of non-attenuatable relation between nodes may be distinct from calculating proximities of attenuatable relation between nodes. In FIG. 6, an intuitive prediction for C's review on restaurant R is a weighted sum of A and B's reviews on R. The weights of the sum may be determined from C's proximities of attenuatable relation to A and B. More specifically, P_{CR1}=(P_{CA0}/(P_{CA0}+P_{CB0}))*P_{AR1}+(P_{CB0}/P_{CA0}+P_{CB0}))*P_{BR1}=(1.0/(1.0+0.187))*5+(0.187/(1.0+0.187))*4=4.842.

Restaurant R may also use G₀ and G₁ to find possible new customers. Assuming R's opinions about A and B are w_{RA1} and w_{RB1} respectively, R's proximity of non-attenuatable relation to C, i.e. R's opinion about C, may be calculated as P_{RC1}=(P_{CA0}/(P_{CA0}+P_{CB0}))*P_{RA1}+(P_{CB0}/(P_{CA0}+P_{CB0}))*P_{RB1}=(1.0/(1.0+0.187))*5+(0.187/(1.0+0.187))*4=4.842.

Assuming vₓ is a node with attenuatable relations and v_{y} is a node with non-attenuatable relations, one embodiment of the present invention may calculate the proximity of non-attenuatable relation from vₓ to v_{y} as

$${p}_{xy} = {\sum }_{i} {pw}_{xi} * {p}_{iy}$$

where vᵢ is one of the nodes having non-attenuatable relations with v_{y} and connected to vₓ by a path with all attenuatable relations on the path. p_{iy} is the proximity of non-attenuatable relation from vᵢ to v_{y}. pwₓᵢ describes the importance of p_{iy} in p_{xy}. In one embodiment of the present invention, pwₓᵢ may be determined as

$${pw}_{xi} = \frac{{p}_{xi}}{{\sum }_{j} {p}_{xj}}$$

where pₓᵢ is the proximity of attenuatable relation from vₓ to vᵢ. vⱼ is one of the nodes having non-attenuatable relation with v_{y} and connected to vₓ by a path with all attenuatable relations on the path. pₓⱼ is the proximity of attenuatable relation from vₓ to vⱼ. The denominator is a sum of all the proximities of attenuatable relation from vₓ to the nodes having non-attenuatable relations with v_{y}.

Similarly, in one embodiment of the present invention, the proximity of non-attenuatable relation from node v_{y} to vₓ may be calculated as

p_{yx}=Σᵢpwₓᵢ*p_{yi}

where vᵢ is one of the nodes having non-attenuatable relation with v_{y} and connected to vₓ by a path with all attenuatable relations on the path. p_{yi} is the proximity of non-attenuatable relation from v_{y} to vᵢ.

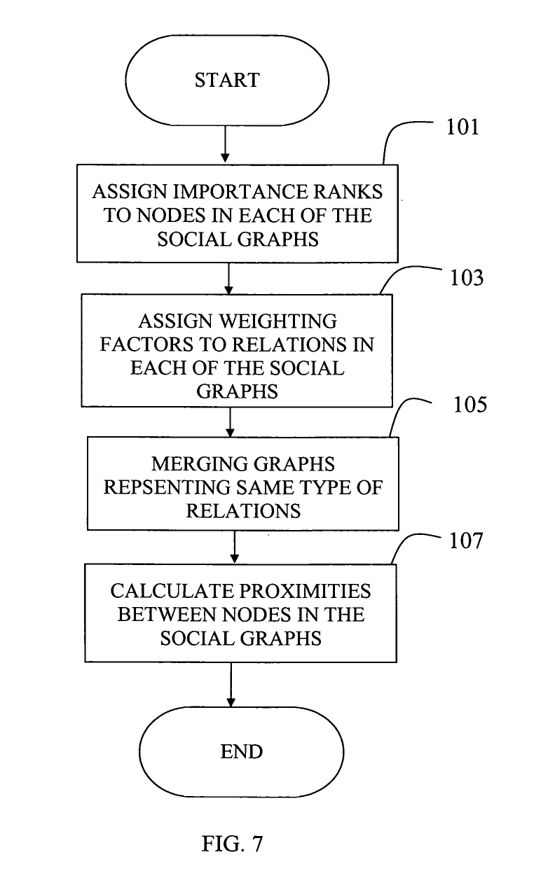

FIG. 7 shows a flow chart of one embodiment of the implementation of the present invention. At step 101, nodes in each of the social graphs are assigned importance ranks. At step 103, weighting factors are assigned to the relations in each of the graphs. At step 105, graphs representing same type of relations are merged into one graph. At step 107, proximities between nodes are calculated.

When proximities between nodes are calculated, search in social graphs may be performed in the order of non-increasing proximities from the source nodes. When presenting the search results, the matched nodes' information/URL links may be listed. The proximities from the source nodes to the matched nodes may be displayed. Moreover, the paths connecting the source nodes to the matched nodes with the maximum path proximities may also be displayed.

It should be noted that the present invention may be applied to one or more social graphs obtained from one or more social networking services.

The present invention has been disclosed and described with respect to the herein disclosed embodiments. However, these embodiments should be considered in all respects as illustrative and not restrictive. Other forms of the present invention could be made within the spirit and scope of the invention.

What is claimed is:

1. A method to calculate proximities between nodes in multiple social graphs, comprising:
obtaining information of a plurality of nodes from a plurality of social networking services, at least some nodes from one networking service being mapped to nodes from other social networking services, at least some of the nodes having relations with other nodes;
assigning a weighting factor to the relation from a first node to a second node associated with each of the social networking services;
calculating the proximity of relation from a first node to a second node, the proximity being dependent on the weighting factors for relations on the paths connecting the first node to the second node; and
processing the nodes according to the calculated proximities between them.

2. The method of claim 1, wherein the nodes are entities registered with social networking services including users, celebrities, public figures, artists, bands, groups, companies, businesses, organizations, institutions, places, events, brands, products and services.

3. The method of claim 1, wherein the assigning a weighting factor includes:
identifying a weighting factor for the relation from a first node to a second node and a weighting factor for the relation from the second node to the first node, the two weighting factors being not equal.

4. The method of claim 1, wherein the calculating the proximity includes:
determining the proximity from a first node to a second node and the proximity from the second node to the first node, the two proximities being not equal.

5. The method of claim 1, wherein the assigning a weighting factor includes:
identifying a weighting factor for the relation from a first node to a second node, the weighting factor being dependent on the number of relations that the first node has.

6. The method of claim 1, wherein the assigning a weighting factor includes:
identifying a weighting factor for the relation from a first node to a second node, the weighting factor being dependent on the closeness of relation between the two nodes.

7. The method of claim 1, wherein the assigning a weighting factor includes:
identifying a weighting factor for the relation from a first node to a second node, the weighting factor being dependent on the communications between the two nodes.

8. The method of claim 1, wherein the assigning a weighting factor includes:
calculating an importance rank for each node; and
identifying a weighting factor for the relation from a first node to a second node, the weighting factor being dependent on the ranks of the two nodes.

9. The method of claim 8, wherein the calculating an importance rank includes:
determining an importance rank for each node, the rank being dependent on the node's profile, join time, last access time, activities, locations, interests, membership of groups and preferences.

10. The method of claim 1, wherein the assigning a weighting factor includes:
identifying a weighting factor for the relation from a first node to a second node based on an estimation of a probability that the second node will be visited from the first node in social search.

11. The method of claim 1, wherein the assigning a weighting factor includes:
identifying a weighting factor for the relation from a first node to a second node based on the review and opinion of the first node about the second node.

12. The method of claim 1, wherein the relations between nodes are attenuatable and may be attenuated when propagated along a path.

13. The method of claim 1, wherein the relations between nodes are non-attenuatable and may not be attenuated when propagated along a path.

14. The method of claim 1, wherein the calculating the proximity includes:
merging same type of relations between nodes; and
determining the proximity of the merged relation from a first node to a second node, the proximity being dependent on the weighting factors for the merged relations on the paths connecting the first node to the second node.

15. The method of claim 14, wherein the merging same type of relations includes:
computing the weighting factors for the merged relations based on the weighting factors for the original relations between nodes.

16. The method of claim 1, wherein the calculating the proximity includes:
computing the proximity of a path connecting a first node to a second node based on the weighting factors for relations on the path; and
determining the proximity from a first node to a second node based on the computed proximities of paths connecting the two nodes.

17. The method of claim 16, wherein the computing the proximity of a path includes:
calculating the proximity of attenuatable relation of a path from a first node to a second node based on the multiplication of the weighting factors for attenuatable relations on the path.

18. The method of claim 16, wherein the computing the proximity of a path includes:
calculating the proximity of attenuatable relation of a path from a first node to a second node based on the multiplication of the weighting factors for attenuatable relations on the path, the weighting factors being attenuated by a propagation coefficient.

19. The method of claim 16, wherein the determining the proximity includes:
calculating the proximity of attenuatable relation from a first node to a second node based on the maximum path proximity from the first node to the second node.

20. The method of claim 16, wherein the determining the proximity includes:
computing the proximity of non-attenuatable relation from a first node to a second node, one of the two nodes having non-attenuatable relations and the other node having attenuatable relations.

21. The method of claim 20, wherein the computing the proximity includes:
finding nodes having non-attenuatable relations with the node having non-attenuatable relations and reachable from the node having attenuatable relations;
calculating the proximities of non-attenuatable relation between the found nodes and the node having non-attenuatable relations; and
determining the proximities of non-attenuatable relation between the two nodes based on the calculated proximities of non-attenuatable relation.

22. The method of claim 21, wherein the determining the proximities includes:
computing the proximities of attenuatable relation between the found nodes and the node having attenuatable relations; and
estimating the proximities of non-attenuatable relation between the two nodes based on a weighted sum of the calculated proximities of non-attenuatable relation, the weightings of the sum being dependent on the computed proximities of attenuatable relation.

23. The method of claim 1, wherein the processing the nodes includes:
displaying the nodes as a directory listing.

24. The method of claim 1, further comprising:
searching the nodes based on predefined criteria.

25. The method of claim 1, wherein the processing the nodes includes:
computing the distances between two nodes, the distances being dependent on the calculated proximities between the two nodes;
creating clusters based on the computed distances between nodes;
searching the created clusters based on predefined criteria; and
displaying the search results as a directory listing.

26. The method of claim 25, wherein the computing the distances includes:
calculating the distances between two nodes based on the reciprocal of the proximities between the two nodes.

27. The method of claim 23, wherein the displaying the nodes includes:
displaying the URL links to the nodes; and
displaying the annotation representing the proximities between nodes.

28. The method of claim 27, wherein the annotation includes the paths connecting the nodes with the maximum path proximities.

29. The method of claim 1, wherein the information of a plurality of nodes may be obtained from one social networking service.
